(19) United States
(12) Patent Application Publication
(10) Pub. No.: US 2025/0317516 A1
(43) Pub. Date: Oct. 9, 2025

(54) SYSTEMS AND METHODS FOR MANAGING CALLBACKS

(71) Applicant: NICE LTD., Ra'anana (IL)

(72) Inventors: Sudarshan KANNAN, Pune (IN); Sean Shem Tov PURDY, Knoxville, TN (US); Salil DHAWAN, Pune (IN); Ronak KHARADKAR, Pune (IN)

(73) Assignee: NICE LTD., Ra'anana (IL)

(21) Appl. No.: 18/628,003

(22) Filed: Apr. 5, 2024

(51) Int. Cl. H04M 3/523; H04M 3/51

(52) U.S. Cl. CPC H04M 3/5231; H04M 3/5191; H04M 3/5233

(57) ABSTRACT

A system and method for automatic scheduling and routing of call data, including, e.g.: sending a scheduling calendar to a first device using a digital messaging channel, where the calendar comprises a plurality of time slots; scheduling an outbound call between the first device and a second device based on a response to the scheduling calendar, where the response comprises a selection of time slots; and transmitting data representing the outbound call using a voice communication channel and based on the scheduling of the outbound call. Some embodiments may include connecting or routing the call to an additional, third device—where the connecting may be based on skills or features required for the call. Time slots in the scheduling calendar may be highlighted based on an availability of resources associated with the relevant skill.

### FIELD OF THE INVENTION

The present invention relates generally to orchestrating or managing communications between computer systems or mobile devices, and more specifically to managing callbacks.

### BACKGROUND OF THE INVENTION

Many calls in a contact center (as well as in various digital communication context unrelated to voice calls) may result a large number of unsuccessful calls such as for example ‘iterative callbacks’ or ‘non-connects’-which may refer to successive unsuccessful communication attempts where a communication event was not properly executed or completed. Unsuccessful communication events may severely hamper the effective utilization of call center resources.

There is a need for intelligent, automatic management of calls and communication events which may improve resource efficiency and utilization in call centers, cloud computing environments, and the like.

### SUMMARY

Embodiments of the invention may provide a system and method for automatic scheduling and routing of call data.

A method of automatic scheduling and routing or transmitting of call data according to some embodiments of the invention may include, e.g.: sending a scheduling calendar to a first computerized device using a digital messaging channel, where the calendar may include a plurality of time slots; scheduling a call between the first device and a second computerized device based on a response to the scheduling calendar, where the response may include a selection of time slots; and transmitting data representing the call using at least one communication channel (such as, e.g., a voice communication channel) and based on the scheduling of the outbound call.

Some embodiments of the invention may include connecting or routing a call to an additional, third computerized device—where the routing may be based on skills or features required for the call and describing or associated with the third device. In some embodiments, time slots in the scheduling calendar may be highlighted based on an availability of resources associated with the relevant skill.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features, and advantages thereof, can be understood by reference to the following detailed description when read with the accompanied drawings. Embodiments are illustrated without limitation in the figures, in which like reference numerals may indicate corresponding, analogous, or similar elements, and in which:

FIG. 1 is a high-level block diagram of an exemplary computing device which may be used with embodiments of the present invention;

FIG. 2 shows an example system of communication devices connected by a network according to some embodiments of the invention;

FIG. 3 shows nonlimiting example call databases according to some embodiments of the invention;

FIG. 4 shows an example system and workflow for managing call records according to some embodiments of the invention;

FIG. 5 shows a block diagram of an example outbound dialer system according the invention;

FIG. 6 shows example priorities associated with skills according to some embodiments of the invention;

FIG. 7 shows an example process for smart handling of inbound wait-queues according to some embodiments of the invention;

FIG. 8 is block diagram showing an example flow from different sources of input to the a call system according to some embodiments of the invention;

FIG. 9 is a flowchart of an example process considering scenarios of iterative callbacks and iterative retries according to some embodiments of the invention;

FIG. 10 is a flowchart of an example process considering a scenario of inbound calls dropped from wait-queues according to some embodiments of the invention;

FIG. 11 shows an example agent to skill mapping database including mapping of calls prioritized according to some embodiments of the invention; and

FIG. 12 shows an example process for automatic scheduling and routing of call data according to some embodiments of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, components, modules, units and/or circuits have not been described in detail so as not to obscure the invention.

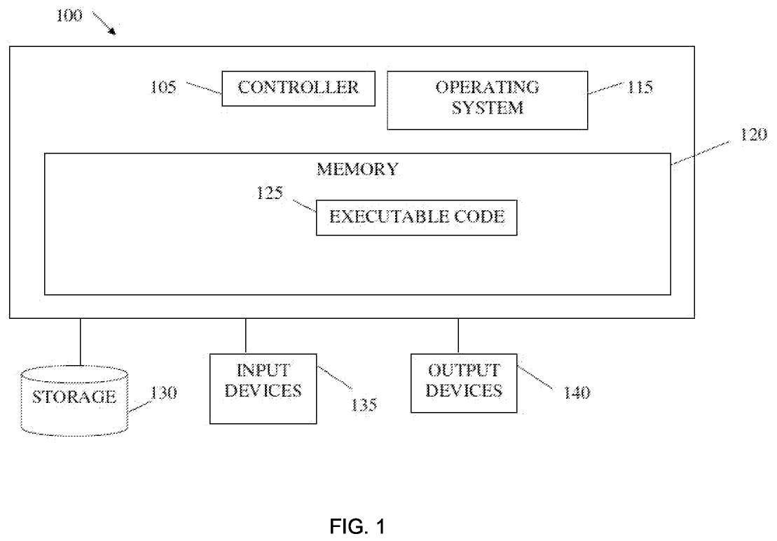

FIG. 1 shows a high-level block diagram of an exemplary computing device which may be used with embodiments of the present invention. Computing device 100 may include a controller or computer processor 105 that may be, for example, a central processing unit processor (CPU), a chip or any suitable computing device, an operating system 115, a memory 120, a storage 130, input devices 135 and output devices 140 such as a computer display or monitor displaying for example a computer desktop system.

Operating system 115 may be or may include code to perform tasks involving coordination, scheduling, arbitration, or managing operation of computing device 100, for example, scheduling execution of programs. Memory 120 may be or may include, for example, a Random Access Memory (RAM), a read only memory (ROM), a Flash memory, a volatile or non-volatile memory, or other suitable memory units or storage units. Memory 120 may be or may include a plurality of different memory units. Memory 120 may store for example, instructions (e.g. code 125) to carry out a method as disclosed herein, and/or data such as low-level action data, output data, etc.

Executable code 125 may be any application, program, process, task, or script. Executable code 125 may be executed by controller 105 possibly under control of operating system 115. For example, executable code 125 may be or execute one or more applications performing methods as disclosed herein. In some embodiments, more than one computing device 100 or components of device 100 may be used. One or more processor(s) 105 may be configured to carry out embodiments of the present invention by for example executing software or code. Storage 130 may be or may include, for example, a hard disk drive, a floppy disk drive, a compact disk (CD) drive, a universal serial bus (USB) device or other suitable removable and/or fixed storage unit. Data described herein may be stored in a storage 130 and may be loaded from storage 130 into a memory 120 where it may be processed by controller 105.

Input devices 135 may be or may include a mouse, a keyboard, a touch screen or pad or any suitable input device or combination of devices. Output devices 140 may include one or more displays, speakers and/or any other suitable output devices or combination of output devices. Any applicable input/output (I/O) devices may be connected to computing device 100, for example, a wired or wireless network interface card (NIC), a modem, printer, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory encoding, including, or storing instructions, e.g., computer-executable instructions, which, when executed by a processor or controller, carry out methods and procedures disclosed herein.

Some embodiments of the invention may relate to contact center environments, in which various technological components may be used for managing data and/or cellular network based communications between computer systems and/or mobile devices. It should be noted, however, that various embodiments of the invention may relate to different environments-such as for example to a cloud computing environment where computerized jobs may be carried out by a computer cluster—e.g., according to a request or command received from a remote computer over a communication network (where, for example, a connection or job execution is interrupted, and a scheduling or rescheduling is required). Example embodiments relating to a contact center environment should therefore be considered nonlimiting.

“Agent” and/or “customer” as used herein may refer, e.g., to computer systems or resources (such as for example system or device 100) or to mobile devices which may or may not be operated by humans, and which may be communicating using a data or cellular network—for example according to the various protocols and procedures described herein. The terms “agent” and/or “customer” may be considered analogous to “source” and “destination”. “Calls” as used herein may refer to cellular or data network based interactions-which may include for example a voice-based conversation between an agent and a customer, and the data involved, such as audio streaming data or recorded audio data, and/or an exchange or transmission of messages or commands between computer systems or resources (e.g., in a cloud computing environment), and the like. Various additional or alternative examples for “calls” or network based communications may be realized and be included in different embodiments.

Some embodiments of the invention may include a plurality of systems, subsystems or components for managing different types of calls. Some such components may be used for managing calls received by embodiments of the invention (e.g., from external sources, such as for example a customer device making a call to a contact center) and may be referred to as “inbound” components. Other components may relate to calls initiated using embodiments of the invention (such as for example a contact center agent making a call to a customer device) and may be referred to as “outbound”. Some embodiments of the invention may use information associated with, or received from, inbound calls for managing outbound calls using dedicated data structures (such as queues and/or lists) and components, such as for example described herein.

In some embodiments, inbound and outbound components may be associated with a different set of agents handling calls. For example, outbound components may include components and/or agents configured or selected to initiate calls or communications with customers (e.g., “outbound agents”), while inbound components may include components and/or agents configured or selected to receive calls or communications (e.g., “inbound agents”). In some embodiments, groups of inbound and outbound agents may not overlap, and/or may each include agents placed in a distinct and/or separate geographic location (for example, inbound agents may be placed in New York, while outbound agents may be placed in Delaware). In some embodiments, inbound and outbound components may be associated with dedicated, separate and distinct inbound and outbound databases-which may for example include or document information about calls and/or agents and/or customers, and may be used such as for example the various example databases described herein.

A “campaign” as used herein may refer to a plurality of technological and/or computerized operations used in, or as part of, orchestrating or managing communications between agents and/or customers-such as for example described in the present document. Some example campaigns described herein may include, for example, a voice campaign (which may for example include operations related to voice-based communications), a digital campaign (which may for example include operations related to digital messaging based communications), and a dialer campaign (which may for example include operations related to connecting or to establishing a connection between devices or systems-such as for example via phone dialing). In addition to the various technological components described herein, various components, protocols and procedures are known in the relevant arts and may be used, for example, to carry out the various operations included in the various processes described herein.

In some embodiments, different campaigns may be executed using different, dedicated technological components and/or software modules which may be needed for each campaign—and separate and distinct campaigns may for example be executed for inbound and outbound calls using separate and distinct components (such that, e.g., components used for executing inbound campaigns are different from ones used for executing outbound campaigns). Such separation or “division of labor” may prove useful, for example, in modern contact center or cloud computing environments, where specification and specialization of resources may be crucial for using the relevant resources in an efficient manner.

Some embodiments of the invention may include sending or transmitting, using a voice communication channel, data representing for example a call (including, e.g., an outgoing or outbound call)—for example to a remote device or computer system via a communication or data network. In some embodiments, data representing a call may be or may correspond to call data (such as, e.g., voice over internet protocol (VOIP) data or data packets), although additional or alternative data may be transmitted or displayed using different embodiments of the invention (see further discussion herein). In some embodiments, data (such as, e.g., data representing a call, or a call being performed) may be transmitted for example based on a scheduling of a call, such as for example described herein.

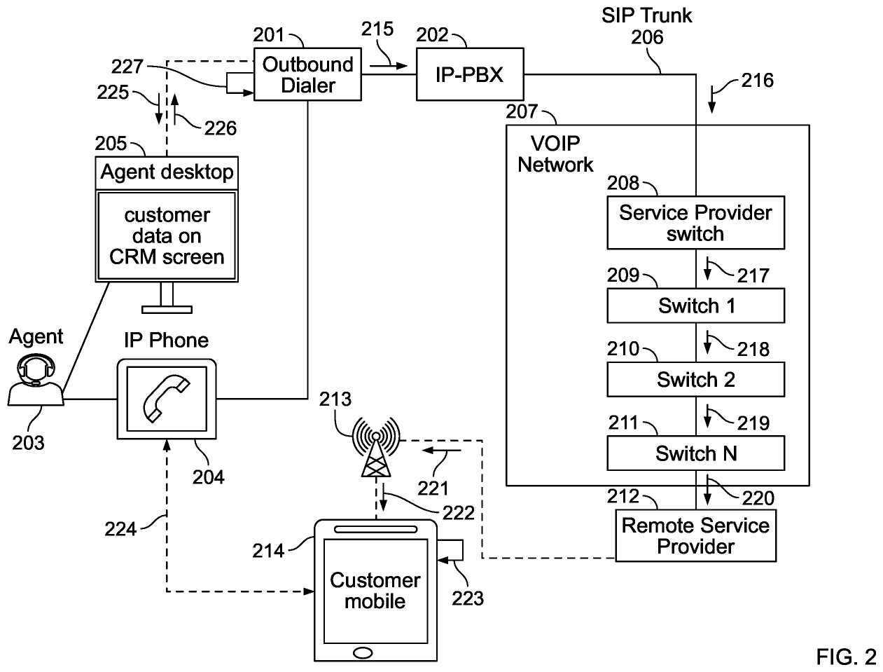

FIG. 2 shows an example system of communication devices connected by a network according to some embodiments of the invention.

Some embodiments of the invention may include sending or transmitting data using at least one communication channel (including, e.g., a voice communication channel) which may for example include or involve a voice over internet protocol (VOIP) component and an internet protocol private branch exchange (IP PBX) component such as for example described herein.

Outbound dialer 201 may dial a customer's phone number and the telephony request may be forwarded to internet protocol private branch exchange (IP-PBX) component or module 202. (e.g., via connection 215). The call request may then be transmitted from IP-PBX 202 to voice over internet protocol (VOIP) network 207. IP-PBX 202 may establish a connection via session initiation protocol (SIP) trunk 206 to a service provider switch or data switch 208 of VOIP network 207 (e.g., using connection 216). The connection request may proceed via a plurality of data switches in the VOIP network path, such as for example via switch 1 209 (connection 217), switch 2 210 (connection 218) and to switch N 211 (connection 219).

From the last switch in the VOIP network path, the connection request may proceed to remote service provider 212 (e.g., via connection 220). The connection request may be transmitted to cellular tower 213 (which may be the nearest one to the customer devices′, e.g., via connection 221) and, via the cellular tower, reach customer mobile device 214 (e.g., via connection 222). At this stage, the outbound call may reach the customer mobile device 214, and the mobile device may perform as when a call is received (e.g. ring along with a visual notification). The customer may then answer or respond to call request 223.

Upon answering the call, a connection-such as, e.g., real time transport protocol (RTP)—may be established between customer device 214 and an agent phone device such as, e.g., IP phone 204—for example via outbound dialer 201. Outbound dialer 201 may also present or display customer data on a user interface (UI)—such as for example on a customer relationship management (CRM) screen of an agent desktop 205—which may for example use data from the data connection between outbound dialer 201 and agent desktop 205 which may for example be sent using connection 225.

A “callback” as used herein may refer to a plurality of scenarios where a communication may have to be resumed, scheduled, or rescheduled. Example scenarios for callbacks such as for example provided herein should be considered nonlimiting.

In one example callback scenario, when the customer may be busy and not able to talk, the customer may ask the agent to call them back at a later time. The agent may then set an appropriate callback date and time, and may for example add (e.g., using a user interface (UI) of a customer relationship management (CRM) application) a tag or label for a corresponding call record, which may be for example a completion code representing a callback. Data changed or entered on a UI and/or CRM screen by an agent along with the callback completion code may then be sent back to outbound dialer campaign 226. The callback completion code for the customer may be recorded in outbound dialer campaign 226 for reporting and filtering purposes. Outbound dialer 201 may then add this callback record into its callback queue for the outbound campaign 227.

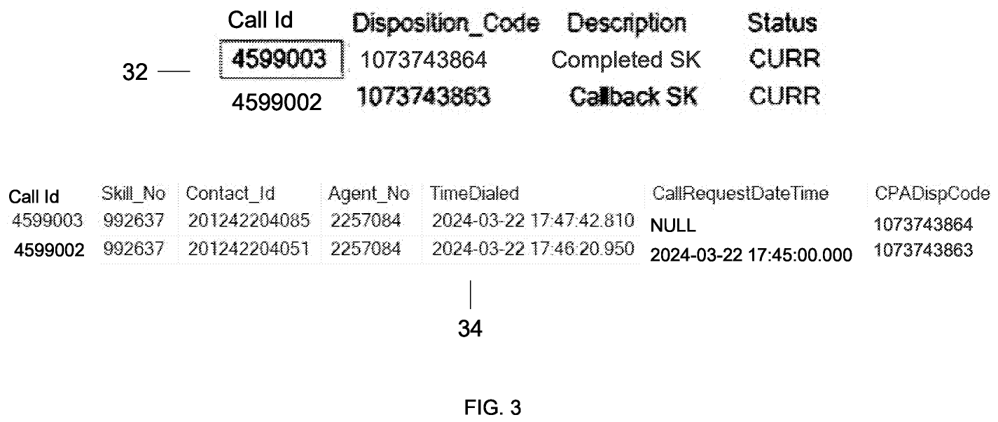

FIG. 3 shows nonlimiting example call databases according to some embodiments of the invention. In the first row of example call database 32, disposition code or completion code ‘1073743864’ may correspond to a status of ‘completed’ and may be used for example to mark calls in which the conversation with a customer is completed and there may be no need for a callback. In the second row of example call database 32, disposition or completion code ‘1073743863’ may correspond to a status or a description of a ‘callback’ and may be used for example to mark calls by an agent after setting a callback date and time, e.g., in a case where the customer asked for callback.

Another nonlimiting example for call database 34 may include additional call data such as for example a skill number or identifier associated with a given call (see further discussion herein), a contact or customer identifier, an agent number or identifier, and the like. In one nonlimiting example use case, an agent may mark one call as completed (first row of example call database 34) and another call as requiring a callback for a later time (second row of example call database 34). The callback time may be captured, e.g., in a ‘CallRequestDateTime’ field. The CPADispCode may be or may correspond to a disposition or completion code where, e.g., ‘1073743864’ may be associated with the completed call and ‘1073743863’ may be associated with the callback and matches (e.g., similarly to example call database 32). Additional or alternative call records and call databases or tables may be used in different embodiments.

In some callback scenarios, a customer may request or ask the agent to call back at a later time and finish the conversation without specifying a convenient time. In other scenarios, the customer may specify or provide a date and time for a callback to take place, and a date and time may for example be determined using the protocols and procedures provided herein.

In an example scenario of a non-connect (which may refer to successive unsuccessful communication attempts where a communication event was not properly executed or completed), a customer device may either not be reachable, or call is not answered by customer. This may result from different reasons, such as for example network congestion, network not reachable, customer mobile busy, customer mobile ringing but there is no answer from customer etc. In some embodiments (such as, e.g., the example embodiment depicted in FIG. 2) a mediating systems such as for example a cellular tower may capture or specify the reason for a non-connect and may for example send or pass it to the relevant remote service provider. The reason may be transmitted back through the VOIP network, for example to the IP-PBX and Outbound Dialer components.

Depending on the configuration for retries on different non-connects, the outbound dialer campaign may push a customer record to an appropriate retry queue. For example, a busy call may be configured to be retried after 15 mins. A network congestion call may be configured to be retried in 30 mins. A ring no answer call may be configured to be retried in 60 mins and so on. Additional or alternative queuing schemes may for example be documented or implemented in a call database such as for example provided herein, and/or may be integrated with existing systems for call queuing and may be used in different embodiments of the invention.

While FIG. 2 shows only one agent with an IP-phone (or endpoint), and one customer device—it is to be understood that various embodiments may include a plurality of agents and a plurality of customers connected to the contact center (see also further description and figures herein). Similarly, it is to be understood that a different number of switches (which may be or may include, for example, layer 2 and layer 3 data switches) may be used throughout in the VOIP network path. Additional or alternative network and contact center architectures may be used in different embodiments of the invention.

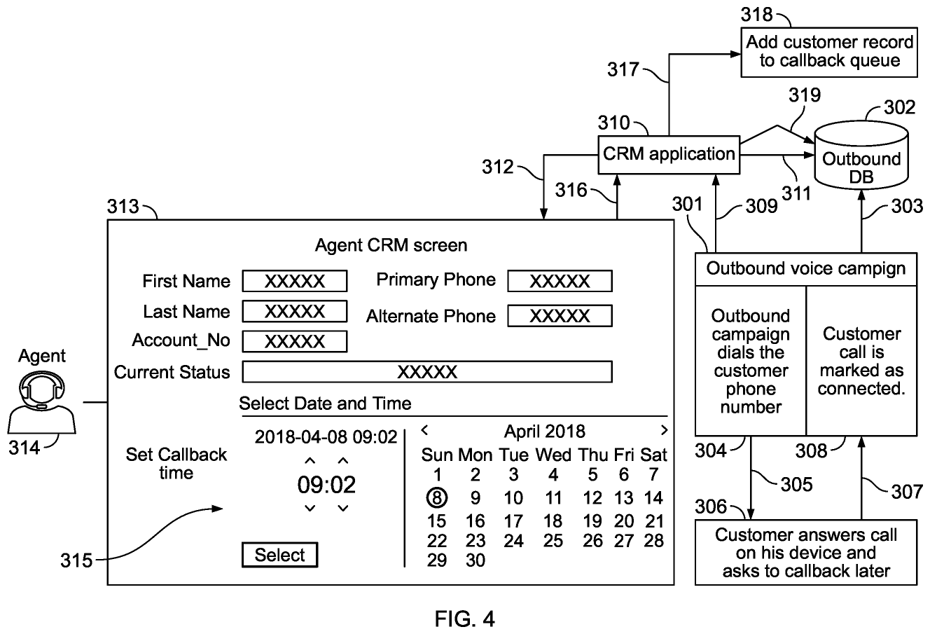

FIG. 4 shows an example system and workflow for managing call records according to some embodiments of the invention.

Some example embodiments may include a connectivity and flow between several components such as for example: outbound voice campaign, outbound call database, customer device, CRM application, and CRM screen or UI (e.g., on an agent's desktop) components—although additional or alternative components and/or connectivity may be used in different embodiments.

Outbound voice campaign 301 may pick or look up a customer record from a database (DB) such as for example outbound database 302, via connection 303. Outbound campaign 301 may then automatically initiate an action 304 to dial the customer phone number. The relevant phone number may then ne dialed and the customer's mobile device may be reached (e.g., via connection 305). The customer may answer the call on his device and may ask an agent to call back later, 306. Outbound campaign 301 may then mark or determine the customer call as a ‘connected’ state 308 and may inform CRM application 310 about the answered customer call and/or the call's state (e.g., via connection 309). CRM application 310 may pull or look up the customer data from outbound DB 302 (e.g., via connection 311) and may present it on CRM screen 313, e.g., on a given agent's UI or desktop (for example via connection 312). An agent 314, using his CRM screen, may for example set an appropriate date and time for a callback 315. The callback date and time 315 set by the agent may then be sent to CRM application 310 (e.g., via connection 316). The CRM application may then add a corresponding record for the call or customer to callback queue 318 (e.g., via connection 317) and may also save callback data of the customer record in outbound DB 302 (e.g., via connection 319).

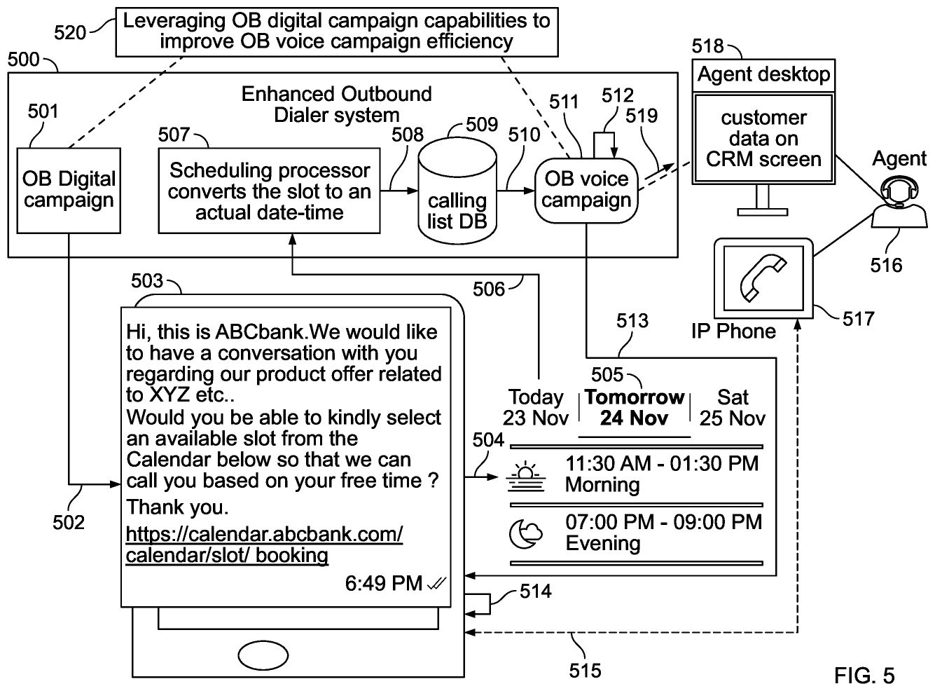

FIG. 5 shows a block diagram of an example outbound dialer system according the invention.

Some embodiments of the invention may include sending, using a digital messaging channel, a scheduling calendar or timetable to a remote device (e.g., using a data or communication network as described herein). In some embodiments, the calendar or timetable may include a plurality of time slots or time windows, which may be used for example as further described herein.

In the shown example enhanced outbound dialer system 500, outbound digital campaign 501 may send a digital message (such as for example a WhatsApp message) to customer's device 503, for example via network connection 502. The message may include, for example, company details and the purpose of the call, although additional or alternative details may be considered in different embodiments. In some embodiments, outbound digital campaign 501 may provide a digital calendar and request the customer to choose an available slot from the calendar, e.g., so that the contact center may make a call to the customer later at the chosen date and time. The calendar may thus act as a scheduler to schedule a voice call with the customer, and may be embedded in the digital message or included or referred to using a HyperText Markup Language (HTML) link in the message which may redirect to a webpage including the calendar. An example of a digital calendar with available slots is shown in element 505 (see also further discussion herein). Additional or alternative methods for including or sending a calendar or scheduling tool may be used in different embodiments of the invention.

In some embodiments, the calendar may be or may include an external plugin or software component such as for example a Google Calendar application programming interface (API) or component which may for example be integrated with a corresponding call or contact center application, such as for example a workforce management (WFM) application. In some embodiments, a given outbound voice campaign may be associated or integrated with a calendar API, plugin or component. The outbound voice campaign may check or consider voice campaign or call priorities (see further discussion herein) and/or an availability of agents associated with the voice campaign (as may be for example documented or described in a call database and/or a corresponding WFM application) and for example automatically create events which may correspond to available time-slots in the calendar and/or in a schedule of the WFM application, denoting times when a call may be made. As further described in nonlimiting examples herein, time slots may be created as 30 minute slots, 1 hour slots, and the like. In one nonlimiting example, an outbound voice campaign (as for example implemented in a corresponding call center or WFM application) may perform operations such as:
1. Connect to a contact center or scheduling database (which may for example include a plurality of schedules for agents or resources, e.g., as part of a WFM application as known in the art).
2. Populate/update/determine availability, or available time slots of relevant agents within the next X hours in the scheduling database.
3. Populate/update/determine priority of the outbound campaign within the next X hours in the scheduling database.
4. Based on steps 2 and 3, populate/update/determine the available time-slots in the scheduling database in which a call may be made to the customer.
5. Connect to Google Calendar API.
6. Execute structured query language (SQL) query to select available time-slots (according to the database; e.g., following step 4)
7. Fill/update/insert/map the available time-slots from the scheduling calendar into the Google Calendar API as events.
   It should noted that various scheduling calendars and databases (e.g., included in WFM applications) as known in the art may be used in different embodiments of the invention.

In some embodiments, the digital calendar may be a pre-fed or pre-processed calendar. For example, an outbound dialer campaign may check agent availability and may include, mark, or highlight only available slots or windows, or slots for which calls have not yet been scheduled (such as, e.g., based on corresponding data fed into a WFM application), in the calendar—and/or include available slots found within a short or predetermined future period (where a ‘short future period’ may be, for example 2-3 days, which may be made configurable). The pre-fed calendar may include masked time slots (e.g., greyed out) where it may not be possible to make a call to the customer—for example due to other priorities like wanting to give preference to fresh records or other calls or callbacks. Such masked out slots may be ‘greyed out’ and their selection may be prevented in the calendar.

The customer may choose one of the highlighted or available slots (date and time) from the available calendar slots that may be shown to him on a digital channel message such as for example a WhatsApp message. Corresponding input from the customer may be received as a response to the scheduling calendar. A response to the scheduling calendar by the customer or user may be received by embodiments of the invention, for example, using the network communication protocols and procedures discussed herein. Embodiments may then process and/or read the response received from a user to update a call list and/or to schedule a call such as for example described herein.

As discussed with reference to one nonlimiting example, a Contact Center application or WFM application may be integrated with a Google Calendar API in which time slots may be populated as events (e.g., calls). Such an integrated Google Calendar API may for example be embedded in a website and be clicked on via a user interface, and the link to the website may be provided to the customer device (which may be, e.g., a mobile device) in the WhatsApp message. The customer may access the website where the Calendar may be embedded and/or presented or rendered, and may then select a time slot from the available time-slots in the integrated Google Calendar embedded within the website. For example, the selection may be or may include user input being received such as clicking on a plurality of 1 hour long time slots, such as, e.g., 12.00-13.00, 14.00-15.00, and the like. The customer or user may click on a slot and the slots clicked on may be taken or considered as a selection, or as a response to the scheduling calendar. Various user interfaces for taking time slot selections or responses by a user are known in the art and may be used in different embodiments of the invention.

Some embodiments of the invention may include scheduling, based on a response to the scheduling calendar, a call between a first device and a second device (which may be for example an outbound call)—or determining a timing for an outgoing call between a first device and a second device. In some embodiments, a response to the scheduling calendar may include a selection of one or more of the time slots or time windows, which may be used for example as described herein.

In some embodiments of the invention, a call (such as for example an outbound call scheduled according to the various protocols and procedures described herein) may be associated with a voice campaign, and a scheduling of a call or a determining of its timing may be performed based on a priority associated with the relevant voice campaign. In some embodiments a scheduling of a call may include or involve automatically selecting or determining an exact time within one or more selected time slots or time windows.

Embodiments may schedule an outbound call between the first device and a second computer device based on a response to the scheduling calendar. For example, once a date and time slot is chosen or selected from the calendar, the relevant slot may be sent to scheduling processor 507 (e.g., via connection 506). Scheduling processor 507 may convert or translate the chosen slot into an actual date and time format (such as, e.g., a timestamp) for example based on and/or after checking the outbound voice campaign's priorities within the slot. For example, if a date and time of Nov 24th, 11:30 AM to 1.30 PM is selected as the slot, scheduling processor 507 may check the outbound campaign's priorities and arrive at an exact date-time to set the voice callback for this customer (see further discussion and examples herein regarding scheduling based on priorities). An exact time can be set, for example, to Nov 24th, 11:45 AM. Scheduling processor 507 may then update the outbound calling list in a call database for the customer record with an exact callback date and time of Nov 24th, 11:45 AM. The calling list in the database may be, e.g., as shown in 509, and a connection between scheduling processor 507 and the calling list in a DB may be, e.g., as shown in 508.

In one nonlimiting example, a voice campaign's priority may be decided by a configuration or setting associated with a given skill or skills (which may be, e.g., associated with a plurality of agents/campaigns such as for example demonstrated herein), and which may for example be determined by a supervisor via a user interface such as for example described herein). In some embodiments, call or campaign priorities may be decided or determined for each given time slot—for example, based on all skills associated with calls scheduled for that time slot or time interval and according to relative priorities or urgencies associated with each of the skills such as for example further demonstrated herein.

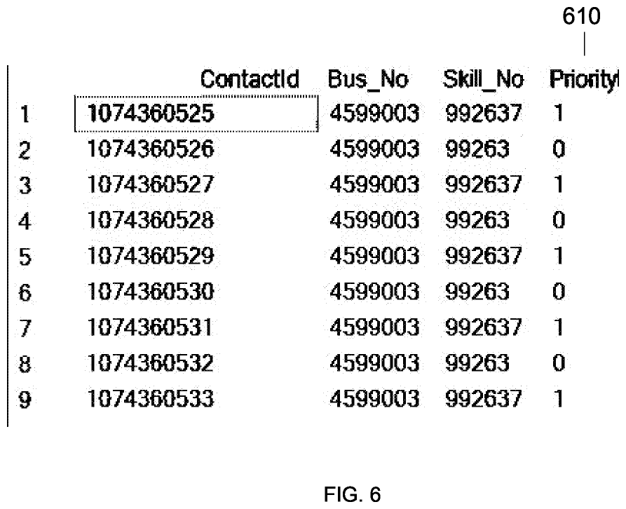

FIG. 6 shows example priorities associated with skills according to some embodiments of the invention. A skill number or identifier (which may for example be denoted as “Skill_No” in relevant databases) may have or be associated with a priority field 610 (which may be denoted as, e.g., “Priority”). In one nonlimiting example, a priority of ‘1’ may be associated with or assigned to skill number ‘992637’, while a default priority of ‘0’ (or “no priority”) may be associated with or assigned to skill number ‘99263’—which may for example lead to calls associated with skill number ‘992637’ being scheduled before calls associated with skill number ‘99263’, such as for example further demonstrated herein. In some embodiments, priorities may be set or determined for example by a supervisor via a user interface, e.g., in a manner similar or analogous to mapping agents with skills such as for example described herein. In some embodiments, priorities associated with a given skill or campaign may be toggled or changed in real time (e.g., by a supervisor) for a given time interval, or for a plurality of intervals.

In some embodiments of the invention, a skill number or identifier may be unique for a given voice campaign, for example in order to distinguish one campaign from another. When a voice campaign is running or being executed, contact or call records may be prioritized for handling, (and may for example be scheduled using a WFM and/or a scheduling calendar such as, e.g., described herein), for example at a time during which a calling list is uploaded or updated. Prioritized calls may accordingly be handled ahead of other queued calls (being less urgent, and less prioritized) which may, e.g., be associated with a different skill such as for example described herein. In some embodiments, priorities may be determined among calls associated with a single skill. In some embodiments of the invention, call or contact records may be prioritized for handling at the time of a calling list upload or update, which may for example be performed by the supervisor or system administrator. The contact records may be, for example, in .csv format and may include a column or field describing a priority, such as for example demonstrated herein. Some example priorities for a call or contact record may be, for example, 1, 2, 3, 4, 5 . . . etc. . . . , where a higher number may refer to a higher priority. In some embodiment, when the csv file gets uploaded (for example to a dialer component), it may be used as a calling list which may be used by the outbound campaign (which may include, e.g., performing calls in order according to the list) . . .

In one nonlimiting example, a priority of 4 may be set for contact_record 1, a priority of 5 for contact_record 2, a priority of 7 for contact_record 3 and and the like. In such an example, priorities may be set for a contact record (for example, manually, by a system administrator and based on the particular customer involved) and there may be only 1 skill associated with the outbound campaign, so the priority may not be based on, or associated with a skill. Priorities relating to skills are further described herein. One skilled in the art that additional or alternative priorities which may relate to agent skills and/or additional variables and/or criteria may be used in different embodiments of the invention.

Outbound dialer voice campaign 511 may be attached to the same calling list and may periodically check the calling list in the DB 509 for callbacks and their scheduled times 510. Voice campaign 511 may add a particular record to its callback queue with the appropriate date and time for scheduled callback 512 (such as, e.g., Nov 24th, 11:45 am). For outbound voice campaign 511, this may refer to the start of the callback time, at which it will try to reach the customer. In some embodiments, outbound voice 511 may try to reach the customer from the scheduled time and may continue to reach the customer periodically (e.g., once in every 5 minutes) if not reachable.

Once, for example, a customer answers the call 514, a voice path (which may be or may include, e.g., RTP connection 515) may be established between the customer device and a contact center's IP Phone 517. Relevant customer data may be populated or displayed on a CRM screen, for example on agent desktop 518 (e.g., via connection 519; see further discussion herein regarding some examples of such data).

In some embodiments of the invention, it may be assumed expected that once a call with customer is established at a time slot chosen or selected by the customer, the agent 516 may have a full conversation with the customer (e.g., a conversation which would not require further callbacks), and that the conversation may reach a proper closure, such that no further calls may be needed. In some other embodiments, future calls may also be scheduled and/or automatically made or performed, for example according to the protocols and procedures described herein.

By using a digital outbound campaign to schedule a call with the customer and later calling the customer at the scheduled time from the outbound voice campaign, embodiments of the invention may improve call management and/or scheduling technologies by allowing for greater efficiency of outbound voice calls or campaigns.

Some embodiments may include sending or transmitting, using at least one communication channel, computer data representing calls (such as, e.g., an outbound or outgoing call) based on the scheduling or the determining of a timing for a call such as for example described herein.

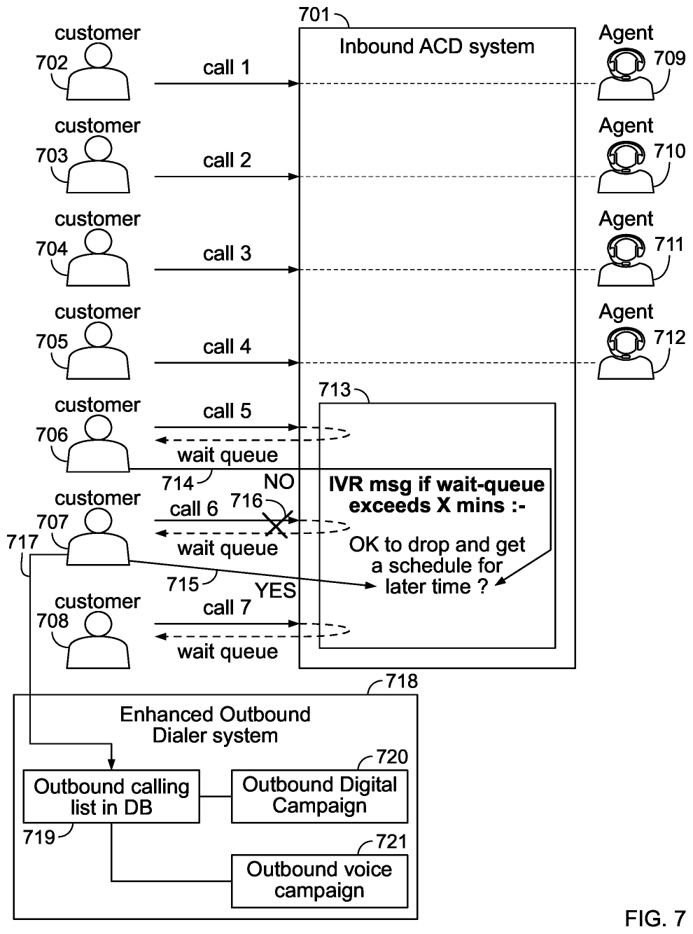

FIG. 7 shows an example process for smart handling of inbound wait-queues according to some embodiments of the invention.

Some embodiments may use or include an inbound ACD (Automatic Call Distributor) system 701 of a call center. A plurality of customers and agents may be considered. For example, customer 702 may be connected to agent 709 (which may be considered as call 1). Customer 703 may be connected to agent 710 (e.g., call 2), customer 704 may be connected to agent 711 (e.g., call 3), and customer 705 may be connected to agent 712 (e.g., call 4). Customer 706 (e.g., call 5), customer 707 (e.g., call 6) and customer 708 (e.g., call 7) may be placed in a wait-queue for their call to be accepted—for example e.g., in an example case where all agents are busy handling other calls.

In some embodiments of the invention, along with a waiting tune or message, an expected wait time (EWT) may be played to the customer waiting in queue-which may be performed e.g., by an interactive voice response (IVR) system or component. In some embodiments, the IVR may provide the customer with an option to choose whether to drop or terminate the current call and let the contact center facilitate a later scheduling of a call with the customer—for example via a digital channel such as, e.g., the WhatsApp messaging service. In some embodiments, only customers or calls waiting in queue for a time period longer than a predetermined threshold may be eligible for such a scheduling or scheduling by the IVR. The eligible wait-time threshold (such as, e.g., 5 minutes) for scheduling may be configurable and different periods may be selected and/or used in different embodiments.

In some embodiments of the invention, the IVR process used in wait-queues may take or receive inputs in the form of digits or as speech. In a nonlimiting example where IVR may receive speech input, the input may be integrated into and/or processed by an advanced speech recognition (ASR) engine. In some embodiments, the IVR or interactive module may be integrated with a text-to-speech (TTS) engine, which may read a text input phrase and/or timestamp containing the calculated EWT on the call (e.g., as included in relevant call databases such as for example described herein), and for example ask the customer whether they prefer that the call center drops the call and communicates with him via, for example, WhatsApp messaging to schedule a call with an agent at a later time.

If the customer agrees to a later scheduling or rescheduling, the relevant voice call in the wait-queue may be dropped or terminated by inbound ACD system 701. Customer data may then be pushed into, or transmitted to, enhanced outbound dialer system 718, which may facilitate scheduling a call with the customer such as for example described herein. For example, the relevant customer's phone number may be taken or extracted using automatic number identification (ANI).

A plurality of data or information items describing the call or customer may be captured and/or displayed by embodiments of the invention, for example based on what the customer had spoken or entered during the inbound call, and/or in response to a plurality of questions presented or transmitted, e.g., using IVR. The inbound system may also look up or search an inbound call DB—for example to check if the customer is an existing subscriber of the company, if so, then it will capture additional available data of the customer (if not-no action may be taken). The data captured may then be pushed into a corresponding outbound dialer's calling list in a relevant DB such as for example described herein, which may be for example a particular calling list between an outbound digital and outbound voice campaigns—although additional or alternative lists and databases may be used in different embodiments of the invention.

If the customer does not agree a later scheduling, then they may, for example, continue to wait and the call will remain in the wait-queue.

In some embodiments, an outbound digital campaign may read or pick up the record from the calling list and reach the customer via digital channel such as for example the WhatsApp messaging service. As, e.g., discussed herein, a message may contain, for example, the purpose of the call along and/or a pre-fed and pre-processed calendar with date-time slots for the customer to choose based on his availability.

In one example, a plurality of customers in the wait-queue (e.g., customer 706 (call 5), customer 707 (call 6) and customer 708 (call 7)) have their wait-times exceeding the eligibility threshold for providing them with the option of later scheduling of their calls with the contact center. Therefore, the IVR may play a message to the customers asking them if they are “OK for the system to drop the current call and schedule for a later time?”, e.g., as shown in 713. Customer 706 may, e.g., respond with a ‘NO’ 714, and may remain in the wait-queue. Customer 708 may not respond to the question, and may thus stay in the wait-queue. Customer 707 may respond with ‘YES’ 715 to the IVR question, and the corresponding call and/or customer data may be captured and pushed 717 to Enhanced Outbound Dialer system 718, which may further facilitate scheduling of a call such as for example described herein.

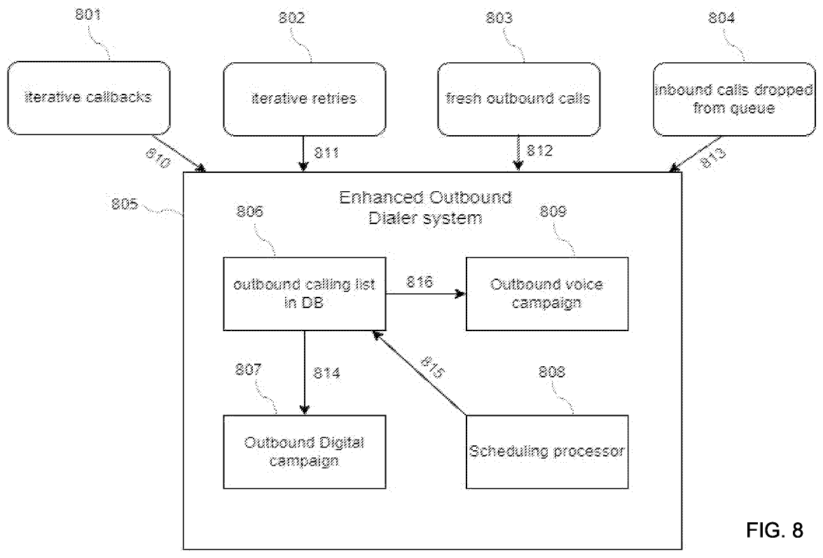

FIG. 8 is block diagram showing an example flow from different sources of input to the a call system according to some embodiments of the invention.

Some embodiments of the invention may include identifying or determining whether or not a call requires scheduling or rescheduling (such as, e.g., described herein), or whether a determining of a timing for a call may be required. In some embodiments, determining whether a call requires scheduling may include checking, using a dedicated database (which may, e.g., be a call or a call record database documenting call events or data such as for example described herein)—or querying the database to determining if a terminated call is, for example: a callback, a non-connect, a first time call, an inbound call dropped, and/or an iterative call. In some embodiments, sending a scheduling calendar or timetable and/or transmitting call data may for example be performed based on the identifying or determining whether a call requires scheduling.

For example, some embodiments may periodically check call records in a call database, calling list or queue (having a form or format such as for example described herein)—which may for example describe or represent a plurality of calls to be performed. Call records may be considered as inputs by some embodiments of the invention when determining whether or not a call requires scheduling. In some embodiments, periodic database checks may be performed for example once in a predetermined time period, such as, e.g., once in 1 hour.

In some embodiments, different example inputs may represent or may be, for example, different problem categories which enhanced outbound dialer system 805 may attempt to address or solve. In some embodiments, different inputs may be received, for example, using dedicated data flows and/or databases, where each flow or database describes a specific category or type of problem or issue associated with a call. For example, Input 801 may be a call record of the category of iterative callbacks in outbound campaigns. The corresponding data flow or input received by system 805 may be represented as connection 810. Input 802 may be a call record of the category of iterative non-connects (retries) in outbound campaigns. The corresponding data flow or input received by system 805 may be represented as connection 811. Input 803 may be a call record of the category of fresh records of outbound campaigns. The corresponding data flow or input received by system 805 may be represented as connection 812. Input 804 may be a call record of the category of inbound customers who dropped from the wait-queue, or calls dropped them from wait-queue after receiving consent from the customer for dropping the call letting the system facilitate a reschedule for a later time. The corresponding data flow or input received by system 805 may be represented as connection 813.

In some embodiments, the different categories of inputs considered by some embodiments of the invention may be represented or documented using identifiers or codes in call records such as for example demonstrated herein.

Example high level components of enhanced outbound dialer system 805 may include outbound calling list or DB 806, outbound digital campaign 807, scheduling processor 808, and outbound voice campaign 809, which may perform or carry out a plurality of protocols or procedures such as for example described herein.

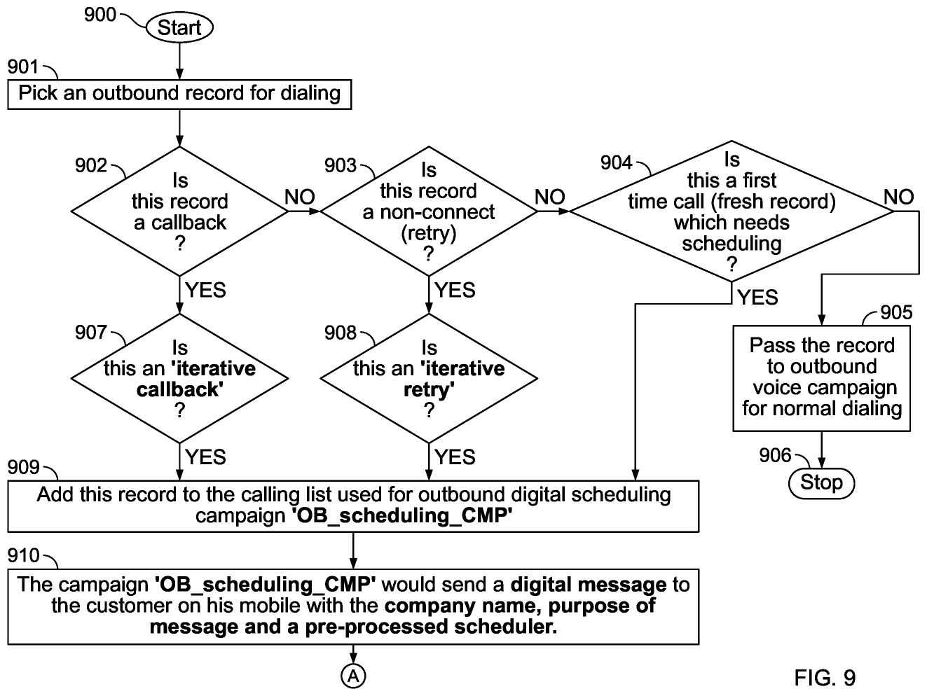

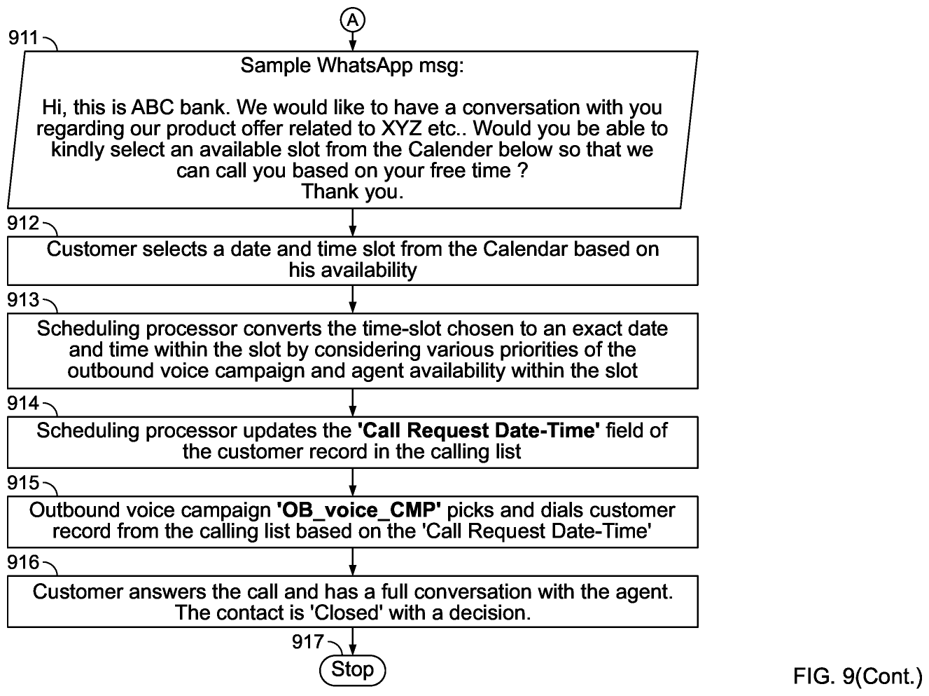

FIG. 9 is a flowchart of an example process considering scenarios of iterative callbacks and iterative retries according to some embodiments of the invention.

Steps in an example process considering scenarios of iterative callbacks and iterative retries may be or may include, e.g., identifying or determining whether or not a call requires scheduling or rescheduling, such as for example:

Operation 901: an outbound dialer may pick or look up an outbound record (which may be for example a call database record) for dialing.

Operation 902: the outbound dialer may check if the record is a callback record, which may for example be determined based on a completion code set in the record (which for example may be set by the agent or done automatically, e.g., upon the receiving of input by the customer such as for example described herein).

Operation 903: If the record is not one of a callback, the dialer may check if the record is a retry record, which may for example be determined based on a completion code set on the record by the system. Retry records may be the non-connects which did not reach the agent, and some embodiments may automatically set completion codes like “Busy”, “Network Congestion”, “Intercept”, “No Answer”, “Answering Machine”, and the like, based on and information provided by various system components and/or corresponding reasons for retries which may be determined such as for example described herein.

Operation 904: If the record is neither a callback nor a retry, the dialer may check if it is a “fresh record” which may be configured for scheduling. In one nonlimiting example, a supervisor may manually select or set a bulk of fresh records for scheduling, which means those customer calls should be scheduled first before calling. In this context, fresh records or call may be or may refer to, e.g., calls or communications with destinations for which no preceding calls were made. Additional or alternative examples may be realized.

Operation 905: If the record does not fall into any of the above categories, it may be passed to the outbound voice campaign for normal processing and dialing, for example, without scheduling. The flow may then reach a stop block at 906.

Operation 907: If the record was a callback as per 902, embodiments may check the configuration count for ‘iterative callback’. In one nonlimiting example, the scheduling feature may not be needed for every callback—and only callbacks which resulting including at least a predetermined number of iterations (e.g., 4 or more times a callback was attempted) may be scheduled or rescheduled according to the protocols and procedures described herein. The dialer may thus check historical attempts on the callback record to identify the number of callbacks or consecutive callbacks set on the record. It may then match it with the corresponding predetermined number of iterations or callback count and determinewhether the callback should be considered iterative.

Operation 908: Similarly, if the record was a non-connect (retry), e.g., as per 903, embodiments may check or determine if the call is an ‘iterative retry’ based on a predetermined or preconfigured retry count or number of retry interactions. For example, only non-connects (retries) resulting in further non-connects (retries) 6 or more times may be scheduled or rescheduled. The dialer may check historical attempts on the non-connect or retry record or corresponding database to identify the number of consecutive retries that happened or took place on the record, and determine whether the call should be considered an iterative retry.

Operation 909: If the record falls into the categories of ‘iterative callback’ or ‘iterative retry’, or if it is a fresh record configured for scheduling, then the record may be added to the calling list used for digital scheduling. A digital scheduling campaign associated with the list may be named, e.g., as: ‘OB_scheduling_CMP’ and the calling list as: ‘list1’.

Operation 910: The digital scheduling campaign ‘OB_scheduling_CMP’ may send a digital message (such as for example a WhatsApp message) to a mobile device, e.g., of a customer. The message may contain the company name and purpose of reaching the customer, a pre-processed calendar and request the customer to choose an available slot, such as for example described herein.

Operation 911: Shows an example message which may be sent to the customer.

Operation 912: A date and time slot from the calendar may be selected based on availability such as for example described herein.

Operation 913: A scheduling processor of the relevant enhanced outbound dialer may convert this date & time slot chosen by the customer to an actual date and time format or timestamp, for example, according to the outbound voice campaign's priorities and agent availability within the relevant time slot. For example, if a customer choses or selects Nov 24th, 11:30 am to 1.30 pm as a time slot for a given call, the scheduling processor may arrive at an exact date-time to set the voice callback for this customer as: Nov 24th, 11:45 am.

Operation 914: The scheduling processor may then update a callback field of the calling list (e.g., ‘list1’) with the converted exact date and time to call back the customer. This callback field of the calling list may be referred to, e.g., as ‘Call Request Date-Time’. For instance, embodiments may update the value in the ‘Call Request Date-Time’ field for the particular customer record as: Nov 24th, 11:45 am.

Operation 915: a running outbound voice campaign (which may be referred to, e.g., as ‘OB_voice_CMP’) may be configured to periodically check for records of the calling list that were updated with a scheduled callback time by the outbound digital scheduling campaign. In some embodiments, periodic checking may be performed, for example, once in a predetermined time period (e.g., every 30 minutes). For instance, the voice campaign ‘OB_voice_CMP’ may check or look up, and pick or select records from calling list ‘list1’ with updated time in the ‘Call Request Date-Time’ field. Once a record is selected or picked up, it may be added to the outbound voice campaign's queue for calling the customer at the date and time scheduled.

As described herein, the time specified in the ‘Call Request Date-Time’ field may be the time for attempting to connect (which may correspond to, e.g., dialing) with the relevant destination (e.g., phone number) by the outbound voice campaign, and some embodiments may re-attempt connect with the destination once in a predetermined, configurable time period in case the destination is not immediately reachable.

Operation 916: a customer may answer the voice call and for example have a full conversation with the agent, and the contact or call may be marked or labeled as ‘Closed’ in relevant call databases such as for example described herein.

Operation 917: The workflow may reach a stop block and may be terminated.

Additional or alternative steps and operations, as well as alternative workflows may be used in different embodiments of the invention.

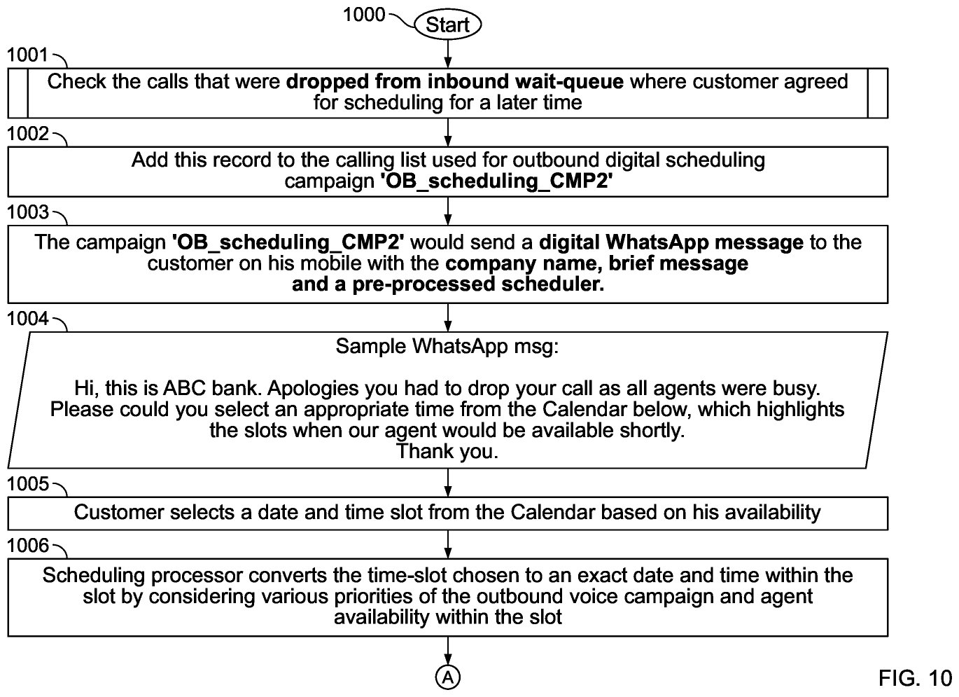

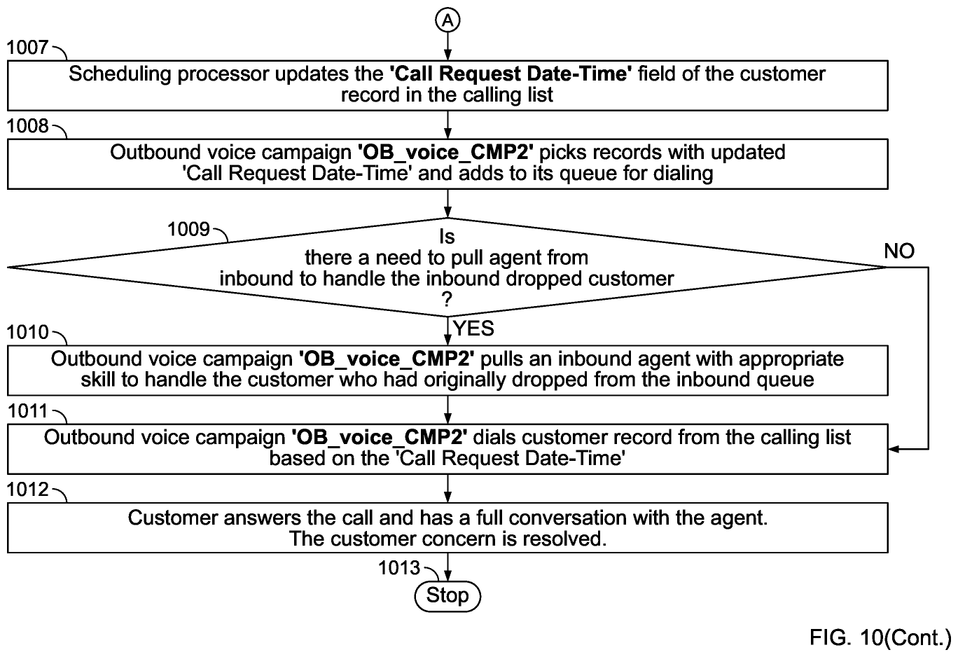

FIG. 10 is a flowchart of an example process considering a scenario of inbound calls dropped from wait-queues according to some embodiments of the invention.

Steps in an example process considering a scenario of inbound calls dropped from wait-queues may be or may include, e.g., identifying or determining whether or not a call requires scheduling or rescheduling, such as for example:

Operation 1001: Embodiments of the invention may check for inbound calls that were dropped from the wait-queue and where, e.g., consent was given for the system to facilitate scheduling of a call for later time such as for example described herein. In some nonlimiting examples, calls that were dropped and/or additional or alternative example calls and call types may be identified, e.g., using completion codes in appropriate database records such as for example described herein.

Operation 1002: Embodiments may add records of calls dropped from the wait-queue, for example, to a calling list used for or included in a digital scheduling campaign, which may for example be referred to as: ‘list2’ and ‘OB_scheduling_CMP2’, respectively.

Operation 1003: The digital scheduling campaign ‘OB_scheduling_CMP2’ may send a digital message (such as for example a WhatsApp message) to a mobile device such as for example a customer device. The message may contain the company name and/or additional details such as for example described herein, and/or a brief apology message, for example, “apologizing for the inconvenience that the call had to be dropped as all agents were busy”. The message may also contain a calendar and a request for the customer to choose an available slot from the calendar such as for example described herein.

Some embodiments of the invention may for example include connecting or routing a call (such as for example a call between two devices, which may be, e.g., an agent device and a customer device) to an additional device (such as e.g., a third device, or a device associated with a different campaign)—for example based on a skill or feature required for the call, where the skill/feature may be recorded in a skill/feature database.

In some embodiments of the invention, depending on the skill set required to handle the inbound customer's dropped call, the dialer campaign may check and consider the future availability of skilled agents, or of agents associated with particular skills (such as for example demonstrated herein with reference to an agent to skill mapping database, and using agent schedules as may be documented or included in, e.g., a WFM application as discussed herein), found within the call center where the call was dropped while in wait-queue. In one nonlimiting example scenario, it may be that outbound agents associated with the outbound campaign considered are appropriately skilled to handle the dropped inbound customer. In that case, the relevant dialer, which may be associated with the outbound campaign considered, may only check the future availability of its own outbound agents.

In some embodiments, and in cases where agents associated with the outbound campaign are not skilled to handle the relevant call, the relevant dialer may perform the call according to schedule and, e.g., when a connection is established-route or connect the call to a different dialer component and/or agent device which may be associated with an agent skilled to handle the call. Various routing protocols and procedures are known in the art and may be used in different embodiments of the invention. Additional or alternative examples of routing or connecting a call based on requirements or skills required for that call may be used or included in different embodiments of the invention.

Some embodiments may mark or highlight a plurality of time slots or windows based on an availability of a resource associated with a relevant skill or feature (as may be documented or included in, e.g., a WFM application as known in the art). Once the relevant dialer has checked the availability of agents or resources with appropriate skills to handle the dropped inbound call, the dialer may automatically mark or highlight the available slots in the calendar based on when a relevant agent or resource may be available and/or based a future time period during which the dialer may make a callback (which may be, e.g., a ‘short future period’ of, for example 2-3 days such as for example described herein). The calendar may have time slots masked (greyed-out), which may refer to time slots during which the dialer may not make a call to the customer due to various reasons, such as for example other priorities like first addressing prioritized fresh records or other callbacks—such as for example further described herein.

Operation 1004: Shows an example WhatsApp message which may be sent to a customer.

Operation 1005: A customer may select a date and time slot from the calendar based on availability, e.g., according to the description herein.

Operation 1006: Embodiments may schedule an outbound call between the first device and a second computer device based on a response to the scheduling calendar. For example, a scheduling processor, for example of an enhanced outbound dialer system according to the description herein, may convert or translate the date and time slot chosen by the customer to a different date and time (e.g., timestamp) format, e.g., using priorities associated with a given voice campaign and agent availability within the time slot such as for example described herein. For example, if a customer choses March 21st, 07:30 μm to 8.30 pm as the slot, the scheduling processor may arrive at an exact date-time to set the voice callback for this customer as: March 21st, 08:00 μm, e.g., if other calls are more highly prioritized and are scheduled to earlier times, e.g., between 07:30 pm and 8.00 pm (see further examples herein).

In some embodiments, call priorities may be used to determine exact call times—where for example a call with the highest priority (e.g., belonging to a voice campaign with the highest priority, where the voice campaign may also be associated with a required call length, such as for example 30 minutes) may be scheduled first, for example at 07:30 pm, given the above example; and a call with the second highest priority (e.g., belonging to a voice campaign with the second highest priority, where the voice campaign may also be associated with a required call length of, e.g., 15 minutes) may be scheduled second, for example at 08:00 pm; a third call belonging to a third voice campaign may subsequently be scheduled at 08:15, and so forth. In some embodiments, calls within a single voice campaign may be prioritized in a first come first served manner, where for example the call received and documented first, e.g., in a call database may be scheduled before the call received and/or documented second, and so forth. Additional or alternative call prioritization schemes (such as for example allowing a quota of calls from a first prioritized voice campaign to be scheduled before scheduling another, different quota for a second prioritized voice campaign—although other examples may be realized) may be used in different embodiments of the invention.

Operation 1007: The scheduling processor may then update the callback field of the calling list ‘list2’ with the converted exact date and time to call back the customer. The relevant callback field may be referred to, e.g., as ‘Call Request Date-Time’. For example, embodiments may update the value in the ‘Call Request Date-Time’ field for the particular call or customer record to: March 21st, 08:00 μm.

Operation 1008: a relevant (e.g., running) outbound voice campaign (denoted, e.g., ‘OB_voice_CMP2’) may be configured to periodically check for records of the calling list that were updated with callback time by the outbound digital scheduling campaign-such as for example described herein.

For example, voice campaign ‘OB_voice_CMP2’ may check and pick records from calling list ‘list2’, for which time in the ‘Call Request Date-Time’ field was updated. Once the record is picked up, it may be added to the outbound voice campaign's dialing or calling queue.

In the nonlimiting example case where scheduling is performed for a dropped inbound call—that inbound call may be associated with or handled by an inbound section or inbound voice campaign—where the inbound section or campaign may include the additional or third device, or a different device associated with a different campaign and/or having the skill relevant or required for handling the call. Connecting the call to an additional device may, in some embodiments, correspond to connecting the call to an inbound agent appropriately skilled to handle the call.

Operation 1009: The system may check if there is a need to “pull” an inbound agent (which may for example correspond to routing the call to an appropriately skilled agent) to handle the customer who had originally dropped on inbound, or if the existing outbound agents are capable of handling the customer based on the skills associated with the relevant agents.

Operation 1010: If there is a need for an inbound or non-outbound agent with a relevant skill, the outbound voice campaign may pull, for example, an appropriate skilled agent from the inbound call section where the customer dropped in wait-queue-which may be done in order to make sure an appropriately skilled agent is available to solve or address the customer concern in the original call.

If, on the other hand, existing outbound agents on the outbound voice campaigns may themselves be appropriately skilled to address the relevant call, then the outbound campaign may not pull an inbound agent before making the call or callback, or after a connection with a destination is established.

Operation 1011: As discussed herein, the time in the ‘Call Request Date-Time’ field may be or may be used as the time the outbound voice campaign would start an attempting (dialing) to reach the destination or customer phone number—and, if needed, the voice campaign may perform subsequent attempts, once in a predetermined time period, e.g., if the destination is not immediately reachable.

Operation 1012: the customer may answer the voice call and, for example, have a full conversation with the agent, and the call may be labeled or marked as resolved.

Operation 1013: the process may reach a stop block and be terminated.

Additional or alternative steps and operations, as well as alternative workflows may be used in different embodiments of the invention.

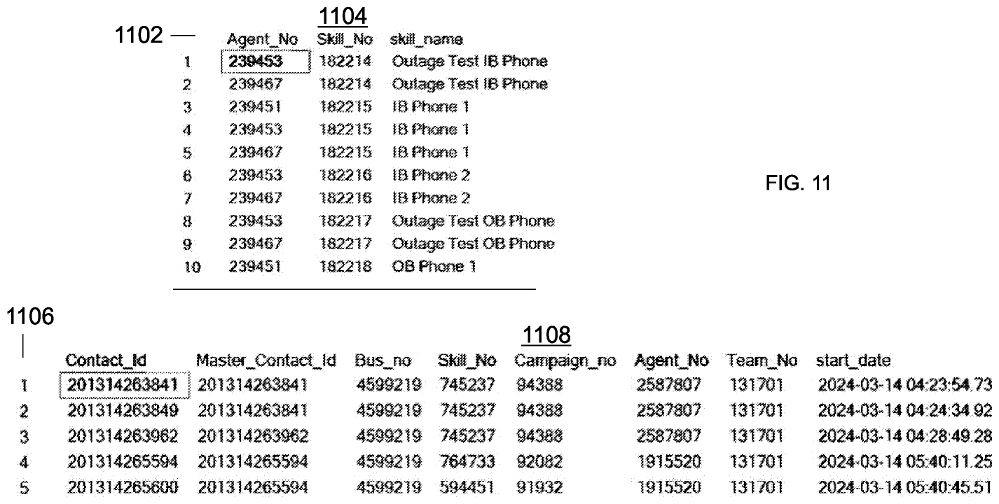

FIG. 11 shows an example agent to skill mapping database including mapping of calls prioritized according to some embodiments of the invention.

Example database 1102 shows different agents associated with various skills—where skills may have corresponding serial numbers or identifiers as well as names 1104. In one example, a skill of handling inbound phone calls may be numbered ‘182215’ and may be named ‘IB phone 1’. Additional or alternative examples may be realized and used in different embodiments. An agent may be associated with an identifier (which may be denoted ‘Agent_No’ or ‘agent_Id’; e.g., ‘239451]), and each agent of a plurality of agents in a call or contact center, or associated with a given campaign, may also be assigned or associated with a skill (e.g., ‘Skill_No’ 182215′ ‘Skill_Name’ IB phone 1). In some embodiments of the invention, the mapping of agents to skills, or vice versa, may be determined or be configured by a supervisor for example via a user interface (such as for example in an appropriate WFM application).

Example database 1106 includes database records of calls (where each call is identified by a corresponding ‘Contact_Id’ field) and campaigns 1108 mapped to or associated with a particular skill (as may be for example specified in a ‘Skill_No’ field), and be scheduled or prioritized according to the skill for example in a schedule for a given agent (as for example noted in the ‘Agent_No’ field and ‘start+date’ field): for example skill ‘764733’ may be prioritized over skill ‘594451’, and/or campaign ‘92082’ may be prioritized over campaign ‘91932’ for agent ‘1915520’: is such a case, a call associated with the prioritized skill and/or campaign, such as for example the call with a ‘Contact_Id’ ending in 594 may prioritized and be scheduled to 05:40:11.250—for example prior to a call with a lesser priority such as for example the call with a ‘Contact_Id’ ending in 600.

In some embodiments, campaigns such as for example voice campaigns may be associated with specific skills. For example an inbound voice call campaign may be associated with a skill of handling inbound phone calls (e.g., ‘IB phone X’, where X=1, 2, . . . n, according to the example shown in database 1102), and be prioritized accordingly, for example in a manner similar or equivalent to that demonstrated herein with regard to prioritizing one skill over another skill. Additional or alternative examples for agent to skill mapping and/or for prioritizing calls or interactions based on skills and/or campaigns may be used in different embodiments of the invention.

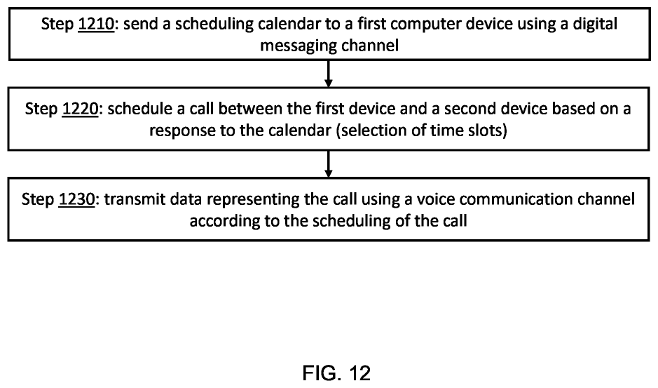

FIG. 12 shows an example process for automatic scheduling and routing of call data according to some embodiments of the invention. In step 1210, embodiments may send a scheduling calendar to a first computer device using a digital messaging channel, where the calendar comprises a plurality of time slots. Embodiments may schedule an outbound call between the first device and a second computer device based on a response to the scheduling calendar, where the response comprises a selection of time slots (step 1220). Embodiments may transmit data representing the call using, e.g., a voice communication channel-based on the scheduling of the call (step 1230). Additional or alternative steps may be included in different embodiments of the invention.

One skilled in the art will realize the invention may be embodied in other specific forms without departing from the spirit or essential characteristics thereof. The embodiments described herein are therefore to be considered in all respects illustrative rather than limiting. In detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention.

Embodiments may include different combinations of features noted in the described embodiments, and features or elements described with respect to one embodiment or flowchart can be combined with or used with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

What is claimed is:

1. A computerized method of automatic scheduling and routing of call data, the method comprising, using a computer processor:
sending, using a digital messaging channel, a scheduling calendar to a first device, wherein the calendar comprises a plurality of time slots;
scheduling, based on a response to the scheduling calendar, an outbound call between the first device and a second device, the response comprising a selection of one or more of the time slots; and
transmitting, using a voice communication channel, data representing the outbound call based on the scheduling of the outbound call.

2. The method of claim 1, comprising determining whether or not a call requires scheduling, the determining comprising checking, using a call record database, if a terminated call is one or more of: a callback, a non-connect, a first time call, an inbound call dropped, and an iterative call; and
wherein the sending of a scheduling calendar is performed based on the determining.

3. The method of claim 1, wherein the outbound call is associated with a voice campaign, wherein the scheduling is performed based on a priority associated with the voice campaign, and wherein the scheduling comprises determining an exact time within one or more selected time slots.

4. The method of claim 1, wherein the voice communication channel comprises a voice over internet protocol (VOIP) component and an internet protocol private branch exchange (IP PBX) component.

5. The method of claim 1, comprising connecting the call to a third device, the connecting based on a skill required for the call, the skill recorded in a skill database.

6. The method of claim 5, comprising highlighting one or more slots of the plurality of time slots based on an availability of a resource associated with the skill.

7. The method of claim 5, wherein the scheduled call is a dropped inbound call, the dropped call handled by an inbound section including the third device.

8. A computerized system for automatic scheduling and routing of call data, the system comprising:
a memory,
and a computer processor configured to:
send, using a digital messaging channel, a scheduling calendar to a first device, wherein the calendar comprises a plurality of time slots;
schedule, based on a response to the scheduling calendar, an outbound call between the first device and a second device, the response comprising a selection of one or more of the time slots; and
transmit, using a voice communication channel, data representing the outbound call based on the scheduling of the outbound call.

9. The computerized system of claim 8, wherein the processor is to determine whether or not a call requires scheduling, the determining comprising checking, using a call record database, if a terminated call is one or more of: a callback, a non-connect, a first time call, an inbound call dropped, and an iterative call; and
wherein the sending of a scheduling calendar is performed based on the determining.

10. The computerized system of claim 8, wherein the outbound call is associated with a voice campaign, wherein the scheduling is performed based on a priority associated with the voice campaign, and wherein the scheduling comprises determining an exact time within one or more selected time slots.

11. The computerized system of claim 8, wherein the voice communication channel comprises a voice over internet protocol (VOIP) component and an internet protocol private branch exchange (IP PBX) component.

12. The computerized system of claim 8, wherein the processor is to connect the call to a third device, the connecting based on a skill required for the call, the skill recorded in a skill database.

13. The computerized system of claim 12, wherein the processor is to highlight one or more slots of the plurality of time slots based on an availability of a resource associated with the skill.

14. The computerized system of claim 12, wherein the scheduled call is a dropped inbound call, the dropped call handled by an inbound section including the third device.

15. A computerized method of automatic rescheduling and sending of call data, the method comprising, using a computer processor:
transmitting, using a digital messaging channel, a timetable to a first device, wherein the timetable comprises a plurality of time windows;
determining, based on a response to the scheduling timetable, a timing for an outgoing call between the first device and a second device, the response comprising a selection of one or more of the time windows; and
sending, using at least one communication channel, computer data representing the outgoing call based on the determining of a timing for the outgoing call.

16. The method of claim 15, comprising identifying whether or not the call requires the determining of a timing, the identifying comprising querying a call record database, the querying to check if the call is one or more of: a callback, a non-connect, a first time call, an inbound call dropped, and an iterative call; and
wherein the sending of a timetable is performed based on the identifying.

17. The method of claim 15, wherein the outgoing call is associated with a voice campaign, wherein the determining of a timing is performed based on a priority associated with the voice campaign, and wherein the determining of a timing comprises selecting an exact time within one or more selected time windows.

18. The method of claim 15, wherein the at least one communication channel comprises a voice over internet protocol (VOIP) and an internet protocol private branch exchange (IP PBX).

19. The method of claim 15, comprising routing the call to an additional device, the routing based on a feature required for the call, the feature recorded in a feature database.

20. The method of claim 19, comprising marking one or more time windows of the plurality of time windows based on an availability of a resource associated with the feature.
